(19) United States
(12) Patent Application Publication
(10) Pub. No.: US 2008/0309073 A1
(43) Pub. Date: Dec. 18, 2008

(54) Composite Tubing Coupling Terminal And Method

(75) Inventors: Richard G. Bach, Kingsley, MI (US); Orlen Jay Norris, Traverse City, MI (US)

Correspondence Address: DOUGLAS S. BISHOP;BISHOP & HEINTZ, P.C., 440 WEST FRONT AT OAK, P.O. BOX 707, TRAVERSE CITY, MI, 49685-0707, US

(73) Assignee: Aurora Oil and Gas Corporation

(21) Appl. No.: 11/903,280

(22) Filed: Sep. 21, 2007

Related U.S. Application Data
(60) Provisional application No. 60/846,585, filed on Sep. 22, 2006.

(51) Int. Cl. F16L 33/00; F16D 1/00

(52) U.S. Cl. 285/222.1; 403/220

(57) ABSTRACT

A specialized coupling device and method for connecting a rigid coupling terminal to specialized composite tubing having a semi-rigid outer tubing combined with an expandable flexible inner tubing with fluid pressure integrity, in a manner which combines fluid pressure integrity with vertical and horizontal load support capability. The end portion of the outer shell of the composite tubing is tapered, with a short portion of the inner tubing extending beyond the taper, both being compatible with the interior of the coupling terminal, together with one or more o-rings positioned within the coupling terminal and around the exposed end of the inner tubing, in combination with an adhesive. An optional interior retaining collet may be inserted from the terminal end within the composite tubing, positioned within the interior circumference of the composite tubing.

### CROSS REFERENCE TO RELATED APPLICATIONS

This application is a Non-Provisional of Provisional (35 USC 119 (e)) Application No. 60/846,585, filed Sep. 22, 2006, entitled “Composite Tubing Coupling Device And Method.”

### FIELD OF THE INVENTION

The present invention is a coupling device and method of connection, to connect a rigid coupling device made of metal, or of other similarly rigid composition, to specialized semi-rigid tubing utilized, particularly, in the oil and gas industry, and otherwise, comprising a semi-rigid outer tube for tensile strength and an expandable flexible inner tube having fluid integrity. Specifically, the present invention design provides a coupling terminal which maintains the fluid pressure integrity of the tubing, but which also will carry a substantial vertical or horizontal weight load, to allow the weight of the tubing, together with any fluid transported within, and any induced pressure, to be supported when utilized horizontally or vertically, in a manner not provided by coupling terminal devices or methods currently existing.

### BACKGROUND OF THE INVENTION

### Description of the Prior Art

The prior art relative to the present invention includes a number of applications designed to couple various types of industrial hosing with coupling terminals or pipe adaptors. In particular, the prior art discloses the connection of a flexible hose with a braided exterior liner, where flexing will not harm the hose, by fitting achieved by applied pressure bonding between the tubing and metal fitting components. This and other applications depend upon the outer shell of the tubing being of an expandable material which can conform to the expanded outer shell of an inserting collet. Other applications relate only to the connection of a connector or terminal to basic single wall tubing, in a connection which will not support significant tensile loads.

In the oil and gas industry, and in other applications, industrial needs often require a composite tubing, with a semi-rigid, semi-porous outer shell, and an inner tubing protected thereby. The outer shell adds tensile strength, and internal burst pressure reenforcement similar to that of a fiber pressure tank. The flexible inner tubing provides fluid pressure integrity. The primary type of this composite tubing has an outer shell of fiberglass and an inner tubing commonly known as High Density Polyethylene or HDPE. Further, as particularly evidenced in the oil and gas industry, such HDPE tubing with a semi-rigid outer shell is often used in vertical applications moving liquid or gas vertically, and as well as in spooled applications (with a minimum radius of six feet) and horizontal applications, and a coupling device must support not only the weight of the composite tubing itself, but any additional load carried thereby, and all force created by induced internal pressure (psi).

Previous solutions addressed to the particular tubing connection addressed by the present invention required removal of the outer semi-rigid fiberglass shell housing from the end of the tubing, insertion of a hose barb inside the tubing and placement of clamps around the outside diameter of the tubing, with the other end of the hose barb threaded into a flange receiver, as well as the application of fiberglass and resin over the exposed tubing around the flange receiver to attempt to reinforce the tubing to its original strength. FIG. 1 of the drawings, below described, is a cross sectional view of a rendition of the prior art, utilizing a hose barb, relative to the tubing which is addressed in this application. As shown, the potential strength of the coupling is minimal, and clearly do not support substantial loads of vertical or horizontal weight, nor of significant induced pressure.

The specialized oil and gas HDPE composite tubing to which the instant invention is primarily directed has a fiberglass reinforced semi-rigid outer shell capable of supporting a tensile load of several thousand pounds, equal to or exceeding 3,500 to 5,000 pounds. This outer shell has a minimum bend radius of approximately six feet. This outer shell, however, does not have sufficient fluid pressure integrity, which is provided by the inner expandable tubing, which tubing, by itself, cannot handle any significant tensile loading. The tubing is desirable in industrial applications, particularly in the oil and gas industry, because it provides tubing of relatively light weight, yet with great strength. Such tubing, however, does need a metal, or like material, connecting or coupling device, to create a removable interface between the tubing and its associated load, and the pipe, or other device, to which it is connected. Other applications of metal connectors to non-metal pipes or tubing, do not address this situation.

Thus, a need exists, not met by current applications, for such a coupling terminal device and method of connection, which will support insertion of composite, fiberglass shell HDPE tubing into an oil and gas well bore, vertically, as well as in spooled or horizontal applications, with a terminal connection capability which will vertically or horizontally support a load of 3,500 to 5,000 pounds or more.

### SUMMARY OF THE INVENTION

The present invention addresses the need, not met by the prior art, for providing an efficient method of connecting composite hosing, with a semi-rigid outer shell of fiberglass or other composite material and an inner expandable flexible HDPE tube, or similar flexible expandable tubing, to a metal coupling device. To form the connection, the outer semi-rigid shell is tapered, in substantially a morse taper, at substantially 2° from its normal outer diameter, around its circumference, toward its end, to a point short of the end of the composite tubing where the tapered outer diameter of the rigid outer tubing meets the outer diameter of the expandable inner HDPE lining. The length of the taper from its point of beginning to where the outer diameter of the rigid outer tubing substantially meets the outer diameter of the expandable inner tubing is determined by the 2° taper. Testing has determined that a taper of substantially 2° is optimum. The taper may be made by circumferentially shaving the outer portion of the rigid outer tube. A short portion of the HDPE inner tubing is left exposed at its end.

A hollow rigid metal coupling terminal device is provided. The terminal device has a threaded or flange, end, or an end otherwise adapted to connection to piping or other equipment. The other end of the coupling device terminal has a compatibly hollow taper to receive the entire tapered end and exposed HDPE portion of the composite hosing within it in compatible, flush male-female relationship. The inner surface of the coupling device is beveled, or scored, or otherwise textured to provide a gripping surface. One or more o-rings within corresponding circumferential grooves of the metal coupling terminal are provided.

An epoxy adhesive is applied to the exterior of the tapered portion of the composite tubing as it is inserted into the coupling device. The o-rings act to keep the epoxy from going further within the coupling device, when the tubing is inserted therein, and, further, as a fluid pressure barrier. Though not required, an optional collet, having an exterior dimension slightly greater than the interior dimension of the flexible tubing, may be inserted through the exterior end of the terminal coupling device and into the flexible inner tubing compressing the flexible inner tubing, outward.

A threaded cap, having a male fitting, insertable within the exterior opening of the coupling device, but larger in diameter than the inner diameter of the collet, may be inserted into the coupling device, in order to force the collet into the tube and to its at rest position within the flexible inner tube.

The above and additional features of the invention may be considered and will become apparent in conjunction with the drawings in particular, and the detailed description which follows.

### BRIEF DESCRIPTION OF THE DRAWINGS

The following detailed description is best understood by reference to the following drawings in which:

FIG. 1 is a cross sectional view of a prior art application;

FIG. 2 is a cross sectional view of the present invention showing the circumferentially tapered outer fiberglass housing, and exposed inner tubing contained completely within the coupling device;

FIG. 3 is an expanded view of the invention showing the circumferentially tapered semi-rigid outer shell, exposed portion of the flexible inner tubing, insertable between a pair of o-rings within the coupling device.

FIG. 4 is a cross section view of the invention, as described in FIG. 2, with an additional retaining collet inserted therein within the end portion of the tubing member.

FIG. 5 is a perspective view of an optional retaining collet;

FIG. 6 is an expanded view showing the end of the composite tubing, with circumferentially tapered outer shell, exposed portion of inner tubing, as insertable through a pair of o-rings within the coupling device, and an optional collet insertable within the interior diameter of the inner tubing.

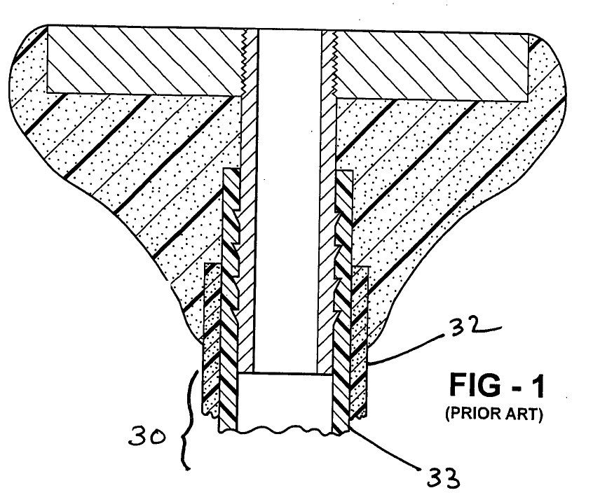

### DETAILED DESCRIPTION OF THE PREFERRED EMBODIMENT

The invention, Composite Tubing Coupling Terminal 10 and Method, broadly considered, includes a coupling member 20 and a composite tubing member 30.

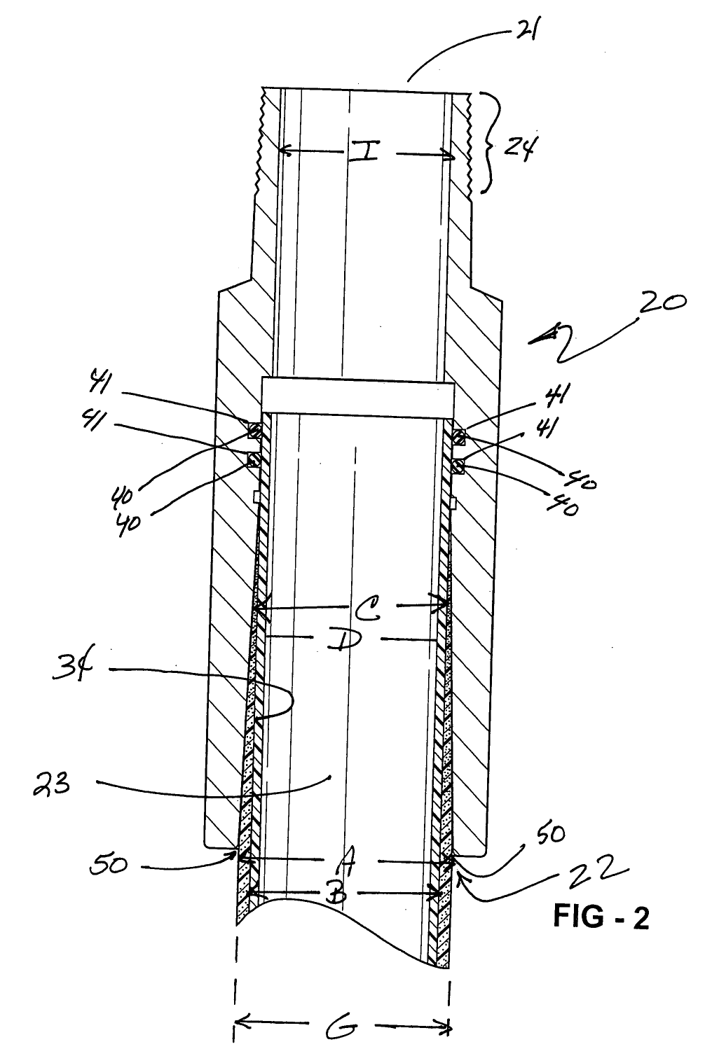

Coupling member 20, as shown in FIGS. 2 through 6, is hollow, with a first interface end 21, a second receptacle end 22, and a hollow interior surface 23. Coupling member 20 is rigid and normally constructed of metal, though other materials such as a ceramic or synthetic material could be substituted so long as they provided like durability and strength. Coupling member 20 at its first connecting end 21 is threaded 24, though a flange or other connection means could be alternately utilized.

Composite tubing member 30 has a first connecting end 31, an outer semi-rigid shell 32, constructed of fiberglass or other semi-rigid material. Said outer shell 32 has an outer diameter A and outer surface 33. Outer shell 32 has an inner diameter B and an inner surface 34.

Composite tubing member 30 additionally has a flexible, expandable inner liner 35 with an outer diameter C and an inner diameter D. Composite tubing member 30 has an outer surface 36 and an inner surface 37.

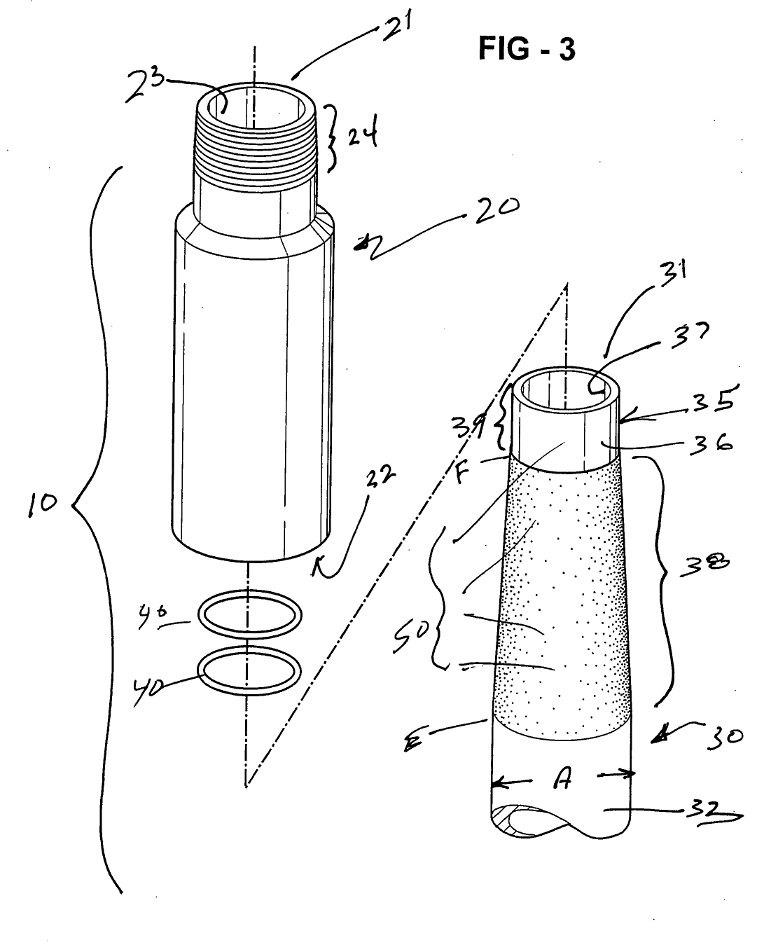

Semi-rigid outer shell 32, as shown in detail in FIG. 3, is circumferentially tapered 38 from a point E at its maximum outer diameter A toward the first connecting end 31 of composite tubing member 30 until the outer diameter A and inner diameter B of outer shell 32 are all substantially equal at point F, where said inner diameter B and outer diameter A are also substantially equal to outer diameter C of inner liner 35. An exposed portion 39 of inner liner 35 extends beyond the end of taper 38 at point F toward and terminating at first connecting end 31. Taper 38 may be a “morse” taper. In the preferred embodiment, said taper 38 is circumferential, at an inward angle of 2°. The length of said taper 38, between points E and F on the outer surface 33 of semi-rigid shell 32 is determined by the angle of taper.

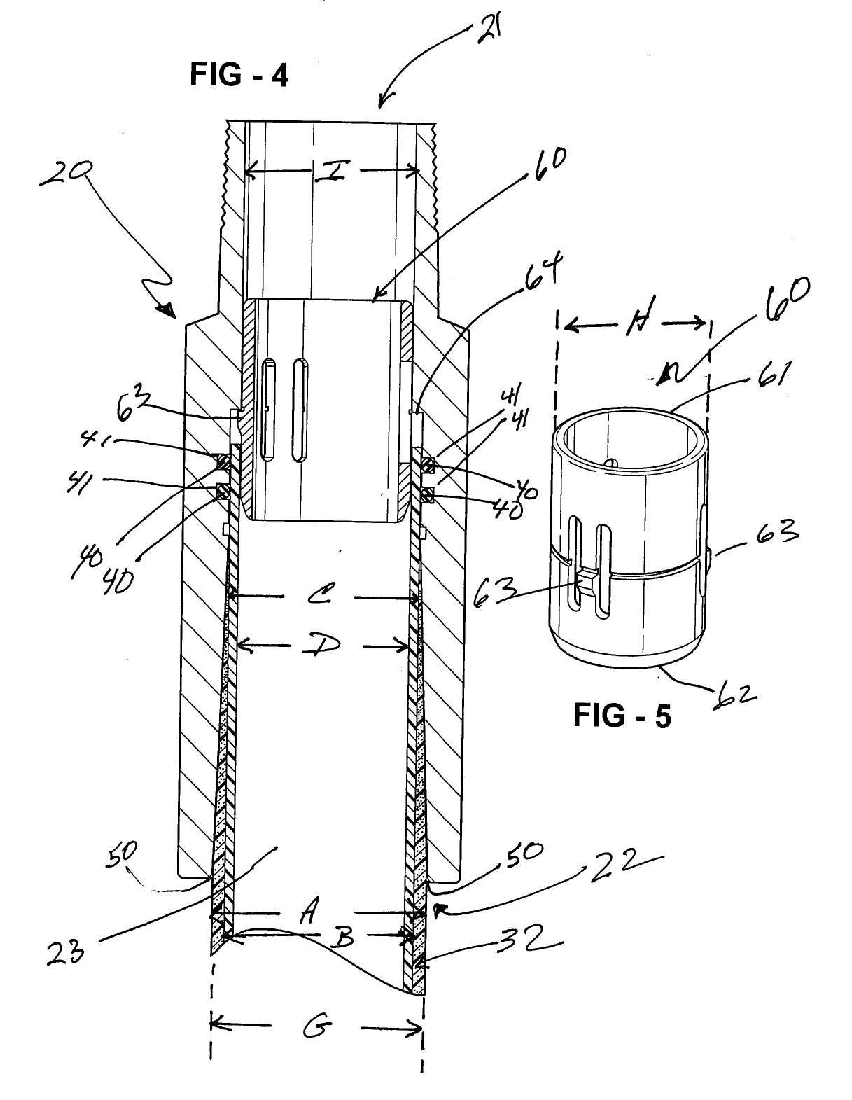

The hollow interior surface 23 of connecting member 20 is conformed as shown in cross section in FIGS. 2 and 4 to accept and mate compatibly with taper 38 and exposed portion 39, in a male-female relationship, when the first connecting end 31 of composite tubing member 30 is inserted through the second receptacle end 22 of coupling member 20. The outer surface 33 and semi-rigid shell 32 and exposed portion of inner liner 35 circumferentially contact and mate with the conformed hollow interior surface 23 of coupling member 20. The hollow interior surface 23 of connecting member 20, in the embodiment shown, is textured to provide a more efficient gripping surface. Said surface texture may be beveled, or otherwise scored or marked to provide such advantage.

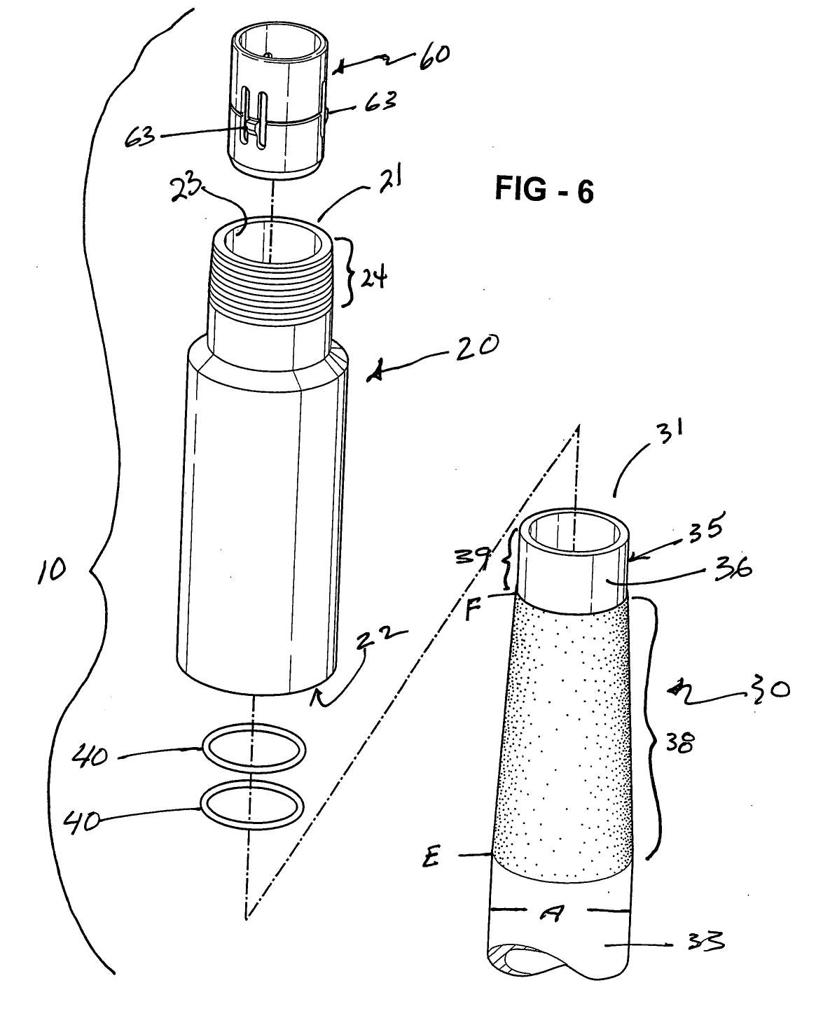

A pair of o-rings 40 are additionally provided, as are a corresponding pair of circumferential grooves 41 as shown in FIGS. 2 and 5. The grooves 41 are on the hollow interior surface 23 of coupling member 20. The o-rings 40 are seated in grooves 41. The embodiment described includes a pair of grooves 41 and corresponding o-rings 40. However, in practice, a minimum of one o-ring 40 and corresponding groove 41 will be satisfactory and more than two o-rings 40 and corresponding grooves 41 may be utilized as well.

The grooves 41 are positioned on the hollow inner surface 23 so that, when the first connecting end 31 is matably inserted within the coupling member 20, each o-ring 40 provided encircles the exposed outer surface 33 of inner liner 35 and each o-ring 40 provided is compressed between outer surface 33 of inner liner 35 and the hollow interior surface 23 of coupling member 20.

The o-ring 40 most proximate point F, where taper 38 ends, keeps excess adhesive 50 from further advancing beyond connecting end 31 as mated within coupling member 20. Adhesive 50 is applied to the taper surface 38 of rigid outer shell 32 and the exposed portion of the outer surface 36 of inner liner 35, prior to insertion into coupling member 20. Adhesive 50 may alternatively be applied to the hollow inner surface 23 of coupling member 20, or to both inner surface 23 and taper surface 38 and the exposed outer surface of inner liner 35. Adhesive 50 may be epoxy-adhesive agent or other alternative adhesive providing a permanent bond.

When the first connecting end 31 is matingly fixed within coupling member 20, the entire tapered surface 38 of semi-rigid shell 32 is within coupling member 20, between its second receptacle end 22 and first interface end 21. The second receptacle end 22 at the opening of the hollow interior surface 23 has a diameter G at least large enough to compatibly accept the hollow tubing member 30 and semi-rigid outer shell 32 with outer diameter A.

The inner liner 35, of composite tubing member 30 is normally comprised of high density polyethylene (HDPE) material which is flexible and expandable and provides fluid and fluid pressure integrity, but is incapable of sustaining significant tensile loads, and, further, cannot withstand, without an outer shell 32, significant induced pressure. The semi-rigid outer shell 32 is normally constructed of fiberglass which may, in fact, be wrapped around inner tubing 35, or otherwise formed thereon. Semi-rigid outer shell 32 normally has a minimum bend radius of 6′, which allows it to be spooled, with that limitation.

The connecting device 10 and method may be utilized to ultimately connect the composite tubing 20 to a separate pipe, or other connective fitting, or, alternatively, may be utilized to connect the composite tubing member 20 to another composite tubing member, of like or similar construction.

Although not required in the primary embodiment of the coupling device 10 and method, a hollow circular collet device 60, having an outer diameter H, a first end 61, second end 62, with outer diameter H being greater than inner diameter D of the flexible inner liner 35, may be additionally provided. Collet device 60 is inserted through the first interface end 21 of hollow coupling member 20 and forcibly seated within the inner diameter D of inner liner 35 further confirming the circumferential compression of each o-ring 40 between outer surface 33 of inner liner 35 and the hollow interior surface 23 of coupling member 20. Collet 60 may have one or more protruding points 63 which will lock the collet in place when inserted within the first interface end 21, by retention within a lip or indentation 64 provided naturally by the normal design of the coupling device 20 wherein the conforming, hollow interior surface 23 is substantially diameter C and the standard industrial diameter I of the first interface end 21 is lesser. Alternatively, the hollow interior surface 23 may be machined to provide one or more retention indentations 64.

The collet 60 may be forcibly inserted, when desired, by use of a solid dowel with an outer diameter greater than the interior diameter of the collet 60, with inward force being applied to the opposing end of dowel until the collet 60 is in place. In one application a solid head cap with a threaded interior rim compatible with threads 24 on first connecting end 21 may be turned into place in contact with the dowel member, forcing the dowel member inward and, coincidentally, forcing the collet 60 into it's desired position within inner liner 35. Said solid head cap may be fixedly attached to such dowel to form a specialized tool for such purpose.

In a claimed overall method for constructing the coupling device 10, the coupling member 20, with all the characteristics above described, together with the composite tubing member 30, as above described, are initially provided. The circumferential taper 38 may be made, by circumferentially shaving the rigid outer shell 32, to the desired angle. The adhesive 50 is applied to provide an adhesive bond between the hollow interior 23 of the coupling member 20, and the tapered first connecting end of the semi-rigid outer shell 32, and tubing member 30. When the adhesive 50 has been applied, the tubing member 20, at its first connecting end 21, is inserted into the conformed hollow interior 23, through the o-rings 40 and fixedly mated therein. The previously described collet 60, is then inserted in the method previously described.

What is claimed is:

1. A coupling device for composite tubing having a semi-rigid outer cover and a flexible inner lining, comprising:
a coupling member having a first interface end, a second receptacle end, and a hollow interior surface;
a composite tubing member having a first connecting end, a semi-rigid outer shell having an outer diameter and surface and inner diameter and surface, and a flexible inner liner having an outer diameter and surface and an inner diameter and surface;
said semi-rigid outer shell being circumferentially tapered toward and ending at a point short of the first connecting end of the tubing member;
the hollow interior of the receptacle end of said coupling member conforming to and accepting compatibly the taper of semi-rigid outer shell and tubing member at its first connecting end.
said hollow interior having a textured surface and at least one circumferential perimeter groove;
an o-ring conformed to each groove; and
an adhesive between the circumferential taper of the surface of the semi-rigid outer shell and the end of the tubing member, and the interior surface of the hollow coupling member;

2. The coupling device of claim 1, further comprising a hollow circular collet device having an outer diameter greater than the inner diameter of the flexible inner tubing, fixably inserted within the inner diameter of the flexible inner tubing.

3. The coupling device of claim 1, wherein the hollow interior textured surface is beveled.

4. The coupling device of claim 1, wherein the semi-rigid outer shell is tapered from its original outer diameter at a 2° angle, to a point where the tapered outer diameter of the semi-rigid shell is substantially equal to the outer diameter of the inner tubing.

5. The coupling device of claim 1, wherein the taper of the semi-rigid outer shell is a morse taper.

6. The coupling device of claim 1, wherein the hollow interior surface of the coupling member has a plurality of circumferential grooves and a corresponding plurality of o-rings conforming thereto.

7. The coupling device of claim 1, wherein at least one o-ring compressibly circumferentially contacts the interior surface of the coupling member and exterior surface of flexible inner liner.

8. The coupling device of claim 1, where the adhesive is an epoxy agent.

9. The coupling device of claim 6, wherein each of said plurality of o-rings compressibly circumferentially contacts the interior surface of the coupling member and the exterior surface of the inner liner.

10. A method of attaching a coupling device to a terminal end of composite tubing having a semi-rigid outer cover and a flexible inner liner, comprising the following steps:
A. Providing a composite tubing member having a first connecting end, a semi-rigid outer shell having an outer diameter and surface and an inner diameter and surface, and a flexible inner liner having an outer diameter and surface and an inner diameter and surface;
B. Tapering the rigid outer shell of the composite tubing member circumferentially toward and ending at a point short of the first connecting end of the tubing member;
C. Providing a coupling member having a first interface and a second receptable end, and a hollow interior;
said hollow interior having a textured surface and at least one circumferential perimeter groove;
a corresponding o-ring for each circumferential perimeter groove, each said o-ring held compatibly therein; and
the hollow interior of said coupling member conformed to completely and compatibly accept the tapered first connecting end of said semi-rigid outer shell, and tubing member;
D. Applying an adhesive over one or more of the tapered portion of the semi-rigid outer shell, the end of the tubing member, and the interior surface of the hollow coupling member.
E. Fixedly inserting the first connecting end of the composite tubing member into the second receptacle end of the coupling member.

11. The method of claim 10, further comprising the following additional step:
F. Fixably inserting a hollow circular collet device, having an outer diameter greater than the inner diameter of the flexible inner tubing, within the inner diameter of the flexible inner tubing.

12. The method of claim 11, wherein Step F is accomplished by placing the collet device within second receptacle end of the coupling member centered upon the flexible inner tubing and fixedly inserting the collet device by applying external force thereto.

13. The method of claim 10, wherein the textured surface of the hollow interior of said coupling member provided in Step C is beveled,

14. The method of claim 10, wherein the taper of the semi-rigid outer shell of Step B is at a 2° angle from the original outer diameter of said outer shell, to a point where the tapered outer diameter of the semi-rigid outer shell is substantially equal to the outer diameter of the inner tubing.

15. The method of claim 10, wherein the taper of Step B is a morse taper.

16. The method of claim 10, wherein the hollow interior surface of the coupling member provided in Step C has a plurality of circumferential grooves and a corresponding plurality of o-rings conforming thereto.

17. The method of claim 10, wherein at least one o-ring of Step C circumferentially contacts the interior surface of the coupling member and the exterior surface of the flexible inner liner of Step A.

18. The method of claim 10, wherein the adhesive of Step D is an epoxy agent.

19. The method of claim 10, wherein each of said plurality of o-rings compressibly circumferentially contacts the interior surface of the coupling member of Step C and the exterior surface of the inner liner of Step A.

20. The coupling device of claim 1, wherein said adhesive is applied to one or more of the circumferential taper of the surface of the semi-rigid outer shell, the end of the tubing member, and the interior surface of the hollow coupling member.
